(19) United States
(12) Patent Application Publication
(10) Pub. No.: US 2026/0229855 A1
(43) Pub. Date: Aug. 6, 2026

(54) SECONDARY POWER GENERATION CONFIGURATIONS FOR DATA CENTERS

(71) Applicant: Tract Capital IP Holdings, LLC, Denver, CO (US)

(72) Inventors: Mislav CRNOGORAC, Zagreb (HR); Eric Ryan WILCOX, Volente, TX (US)

(73) Assignee: Tract Capital IP Holdings, LLC, Denver, CO (US)

(21) Appl. No.: 19/532,884

(22) Filed: Feb. 6, 2026

Related U.S. Application Data
(60) Provisional application No. 63/755,166, filed on Feb. 6, 2025.

(51) Int. Cl. H02B 7/06; H02B 1/20

(52) U.S. Cl. CPC H02B 7/06; H02B 1/202

(57) ABSTRACT

A data center comprises a data hall building and a secondary power generation building housing a plurality of secondary power generation devices. The secondary power generation building may house a switchboard, and a plurality of medium-to-low-voltage distribution transformers coupled to utility power and configured to step-down the utility power to a transmission voltage. One or more cables may transport power from the secondary power generation building to the data hall building at the transmission voltage. One or more transformers may be coupled to one or more of the plurality of secondary power generation devices and configured to step up power generated by the one or more secondary power generation devices to a transmission voltage. One or more cables may transport the stepped-up power from the one or more secondary power generation devices to the data hall building at the transmission voltage.

### CROSS-REFERENCE TO RELATED APPLICATIONS

This application claims the benefit of U.S. Provisional Application No. 63/755,166, filed Feb. 6, 2025, the entire contents of which are incorporated herein by reference.

### FIELD

This relates to data center designs, and more particularly to data center configurations for secondary power generation, switching equipment, and cooling equipment.

### BACKGROUND

Conventional data center designs locate secondary power generation equipment within or in close proximity to a data hall building that contains one or more data halls. Typically, generators for secondary power generation are located at ground level directly adjacent to the data hall building.

### SUMMARY

As disclosed herein, improved data center designs may locate secondary power generation equipment, such as generators and associated equipment, in a building separate from the data hall building. Power from the generator building may be stepped up, for example 30 kV or more (and in some embodiments 34.5 kV). Transmitting power from the generator building to the data hall building at a higher voltage (e.g., voltages disclosed herein) may minimize transmission losses. In some embodiments, some or all switching equipment, such as medium voltage change-over panels, may be located in the generator building rather than in or proximate to the data hall building. Medium voltage uninterruptible power supplies (UPS's) can be placed in the generator building, in some embodiments. In some embodiments, locating secondary power generation equipment in a separate building spaced apart from the data hall building may free up ground-level space adjacent to the data hall building that would, in conventional designs, have been used for generators. By freeing up this ground-level space adjacent to the data hall building, cooling equipment may, in some embodiments, be placed at ground level adjacent to the data hall building, rather than being placed on the roof of the data hall building.

As disclosed herein, improved data center designs may locate secondary power generation along with other electrical equipment, in an electrical systems building separate from the data hall building. The electrical systems building may be separate from, but located a medium to close proximity to, the data hall building. The electrical systems building may in some embodiments be located at a minimum fire-safe distance (e.g., 60 feet) from the data ball building. This distance may be sufficient to ensure no substantial effects from heat exchange between the two buildings, but it may be short enough that low-voltage power transfer from the electrical systems building to the data hall building does not result in substantial transmission losses. Thus, power from the electrical systems building may be conveyed to the data hall building at low voltage ranges.

In some embodiments, a data center comprises: a data hall building housing a plurality of computer devices; a secondary power generation building housing a plurality of secondary power generation devices, and a switchboard; one or more cables electrically coupled to the one or more secondary power generation devices, to the utility power, and to the data hall building, wherein the one or more cables are configured to transport power from the secondary power generation building to the data hall building.

In some embodiments, the secondary power generation building houses a plurality of medium-to-low-voltage distribution transformers coupled to utility power and configured to step-down the utility power to a transmission voltage, wherein the one or more cables are configured to transport power from the secondary power generation building to the data hall building at the transmission voltage.

In some embodiments, the transmission voltage is less than or equal to 1000 V.

In some embodiments, the secondary power generation building is spaced apart from the data hall building by a distance of greater than or equal to 60 feet.

In some embodiments, the secondary power generation building houses switching equipment configured to perform utility-to-generator changeover switching.

In some embodiments, the switching equipment comprises low-voltage changeover panels.

In some embodiments, the data hall building comprises heat rejection equipment that has a heat rejection capacity calibrated for less than or equal to 110% of a nominal heat rejection capacity corresponding to a heat generation level of the data hall building when the data hall building is in an operational status.

In some embodiments, the heat rejection equipment is located on a roof of the data hall building.

In some embodiments, the data hall building comprises a cooling gallery at ground level.

In some embodiments, a data center comprises: a data hall building housing a plurality of computer devices; a secondary power generation building housing a plurality of secondary power generation devices; one or more transformers coupled to one or more of the plurality of secondary power generation devices and configured to step up power generated by the one or more secondary power generation devices to a transmission voltage; one or more cables coupled to the one or more transformers and to the data hall building, wherein the one or more cables are configured to transport the stepped-up power from the one or more secondary power generation devices to the data hall building at the transmission voltage.

In some embodiments, the transmission voltage is 37.5 kV.

In some embodiments, the secondary power generation building is spaced apart from the data hall building by a distance of greater than or equal to 100 feet.

In some embodiments, the secondary power generation building houses switching equipment configured to perform utility-to-generator changeover switching.

In some embodiments, the switching equipment comprises medium-voltage changeover panels.

In some embodiments, the data center comprises cooling equipment located at ground-level at a perimeter of the data hall building.

In some embodiments, a roof of the data hall building is free of cooling equipment.

In some embodiments, any of the features of any of the embodiments described above and/or described elsewhere herein may be combined, in whole or in part, with one another. For example, any features of any secondary (e.g., non-data-hall) building described herein, such as any building referred to as a generator building and/or any building referred to as an electrical systems building, may be combined, in whole or in part, with one another. Additional advantages will be readily apparent to those skilled in the art from the following figure and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figure of which:

FIG. 1A depicts a data center, in accordance with some embodiments.

FIG. 1B depicts a data center, in accordance with some embodiments.

FIG. 2 depicts a data center, in accordance with some embodiments.

### DETAILED DESCRIPTION

As noted above, conventional data center designs locate secondary power generation equipment within or in close proximity to a data hall building that contains one or more data halls, typically at ground level directly adjacent to the building. Secondary power generation is conventionally located in close proximity to the data hall building in order to reduce the length of feeder runs from secondary power generators to the data hall building, thereby minimizing power losses between the generators and the data hall building. However, arranging secondary power generation equipment in close proximity to the data hall building also creates several drawbacks, including the need to manage heat and exhaust generated by the generators when they are in use. If left unmanaged, the heat and exhaust created by the generators can damage, stress, or negatively impact performance of cooling equipment or other equipment located in or near the data hall building.

In order to manage the heat and exhaust created by generators located in close proximity to a data hall building, extensive systems of heat shrouding and/or ductwork to divert exhaust and heat away from the data hall building. These systems for heat and exhaust management are complex and expensive and may require frequent maintenance.

Accordingly, improved data center designs are needed that provide secondary power generation in a more efficient, effective, and resilient manner. Disclosed herein are data center designs that address the above-identified problems and needs.

Systems and methods disclosed herein may include data centers designed to prioritize safety, simplicity, and/or long-term operational efficiency. An exemplary data center may be structured to support long-term operation with components making up the data center and/or underground utilities designed for extended operation. A data center can be a single building or structure or include multiple buildings/structures and/or other components or facilities. For example, components may be designed to last 50 or more years. To increase environmental sustainability, a data center may be designed to include biodiverse landscaping, use of municipal recycled water, implementation of energy-and water-efficient practices, use of low global warming potential refrigerants, and/or selection of construction materials that minimize embodied carbon dioxide, such as low-carbon concrete and/or low-carbon steel. Sustainability efforts may also include the management of construction waste, energy consumption during construction, and/or water usage during construction.

An exemplary data center may include one or more data halls that in turn may include independent sections or areas referred to as phases. A data hall can be a standalone building or structure or a portion of a building or structure. A phase may include server racks, electrical lineups transferring power to the server racks, and/or cooling units transferring heat away from the server racks. In some embodiments, a data hall can include at least one computer device, including for example one or more servers, storage devices, processors, network communication devices (e.g., switches, routers, firewalls, etc.), etc. In some embodiments, a data hall can include a plurality of networked computer devices. In some embodiments, a data hall phase may include at least one computer device and/or a plurality of networked computer devices. In some embodiments, an electrical lineup may refer to a configuration of equipment supplying power to a designated portion of a data center. In some embodiments, the configuration of equipment can include a set of electrical distribution equipment supplying power to the designated portion of the data center. In some embodiments, an electrical lineup can include, for example, switching components, cabling, and/or power distribution units. For example, a phase may include at least one electrical lineup, at least two electrical lineups, at least three electrical lineups, at least four electrical lineups, at least five electrical lineups, at least six electrical lineups, at most six electrical lineups, at most five electrical lineups, at most four electrical lineups, at most three electrical lineups, at most two electrical lineups, and/or at most one electrical lineup.

Phases of data halls may form independent structural and/or operational units, allowing incremental expansion without impacting already commissioned sections. Following construction of the core and shell of an exemplary data center building, the installation and/or fit-out of mechanical, electrical, and plumbing systems may be performed on a per-phase basis without affecting the operation of existing phases. An exemplary phase may include at least one aisle, at least two aisles, at least four aisles, at least six aisles, at least eight aisles, at most eight aisles, at most six aisles, at most four aisles, at most two aisles, and/or at most one aisle. An exemplary phase may include at least one row, at least two rows, at least four rows, at least six rows, least eight rows, at least ten rows, at least 12 rows, at most 12 rows, at most ten rows, at most eight rows, at most six rows, at most four rows, at most two rows, and/or at most one row. In some implementations, a first-built phase of an exemplary data center may include more rows than one or more later-built phases.

A data center may include an electrical system based on a standard power capacity of one or more of the electrical lineups transferring power to server racks and/or other IT equipment. For example, said electrical lineups may have a standard power capacity of at least 0.5 MW, at least 1 MW, at least 1.5 MW, at least 2 MW, at least 2.5 MW, at least 2.75 MW, at least 3 MW, at least 3.5 MW, at least 4 MW, at most 4 MW, at most 3.5 MW, at most 3 MW, at most 2.75 MW, at most 2.5 MW, at most 2 MW, at most 1.5 MW, at most 1 MW, and/or at most 0.5 MW.

Use of standard electrical lineups forming a phase of a data hall may enable incremental data center construction as mentioned above. For example, a phase may include one or more electrical lineups transferring power to one or more server racks and/or other IT equipment. Electrical lineups may additionally or alternatively transfer power to mechanical loads, for example mechanical loads corresponding to facility cooling. Additionally or alternatively, a phase may include one or more reserve electrical lineups to provide redundancy to electrical lineups transferring power to server racks and/or other IT equipment and/or to electrical lineups transferring power to mechanical loads. The number of electrical lineups transferring power to mechanical loads may vary depending on the cooling technology selected for a specific site.

An exemplary electrical lineup may use a bus duct system for power distribution, with the bus duct current rating determined based on factors such as voltage drop constraints. For example, an electrical lineup may include an aluminum bus duct rated for 4000 A. Each server rack or server rack grouping may receive one or more separate power feeds, for example each may receive two power feeds for redundancy. Power from a utility substation or other medium-voltage source may be routed through distribution equipment (e.g. switchgear) to one or more transformers. Said one or more transformers may use oil for cooling and/or insulation and may have built-in automatic fault protection. Said transformers may be arranged in a looped system with a single open point in each loop to prevent direct connections between different power sources, thereby improving reliability and/or fault isolation.

An exemplary data center may include a facility cooling system configuration designed to increase energy efficiency by leveraging opportunities for free cooling and reducing reliance on mechanical cooling systems. Different areas of a data center including, for example, data halls, electrical rooms, and/or offices, may have distinct cooling setpoints to optimize efficiency. For example, using a higher data hall aisle temperature setpoint may extend free cooling operation. Airflow distribution within an exemplary data hall may be based on a flooded room approach. For example, air may be delivered throughout a data hall and/or to one or more aisles from one or both sides of the one or more aisles. An exemplary facility cooling system may define a maximum allowable duration for which a data center facility may operate outside acceptable temperature and/or humidity ranges before triggering an error escalation.

Facility cooling systems may be based on indirect evaporative cooling and may include dry coolers with evaporative media pads, for example. Additionally or alternatively, facility cooling systems may include chillers (e.g. trim chillers and/or air-cooled chillers) and/or adiabatic cooling systems such as adiabatic chillers. An exemplary facility cooling system may include one or more fan blocks, for example one or more sets of fans, and/or one or more evaporative cooling blocks, for example one or more cooling units based on indirect evaporative cooling as discussed above. Facility cooling system redundancy may be designed to meet an “N+2” standard per fan block and/or per evaporative cooling block, where “N” represents a minimum number of units for normal operation and “+2” represents two backup units. Additional data center redundancies may include an “N+1” configuration for medium-voltage room split-system cooling units, an “N+1” configuration for high-voltage to medium-voltage client control room split-system cooling units, and/or an “N+1” configuration for critical fuel oil pumps. An exemplary data center may also include makeup water storage tank redundancy set at “N” and/or an “N+1” redundancy configuration for industrial water purification skid systems.

An exemplary air-based server cooling system may be designed to maintain server air intake temperatures within a normal operating range of 10° C. to 35° C. An air-based server cooling system may interface with one or more servers within a data hall to reduce the risk of thermal degradation. For example, a cooling system may set a maximum server air intake temperature above which server degradation may occur, for example a system may set a maximum temperature between 35° C. and 45° C. A cooling system may throttle the processors of one or more servers if server air intake temperature is between 40° C. and 45° C., and/or may shutdown one or more servers if intake temperature exceeds 45° C. to 50° C. An air-based server cooling system may additionally maintain humidity levels below 60% to 75% relative humidity, and cooling system airflow may be limited to 170 CFM per server rack kW.

An exemplary liquid-based server cooling system may include specifications for cooling liquid filtration levels, pressure limits, and/or flow rates. The cooling liquid used in such a server cooling system may be water, PG25, and/or a similar heat transfer fluid. The filtration of a server cooling system may include a particle filter, for example a 50-micron filter. A cooling system may set the minimum server liquid inlet temperature to the dew point plus 2° C., and/or may set the maximum server liquid inlet temperature to 28° C. to 34° C. A cooling system may further set the maximum server liquid outlet temperature to 59° C. A cooling system may set the maximum allowable server rack flow rate to 4.0 LPM per server rack kW, the minimum server rack flow rate to 0.7 LPM per server rack kW, the minimum supply pressure for filling the system to 35 PSI, and/or the maximum server inlet pressure to 100 PSI. The maximum fluid volume for a system may be 40 L.

The specifications for liquid-based server cooling systems can assume constant liquid flow. This flow may be set using flow setters supplying a server rack from a main row liquid manifold. A liquid-based server cooling system may involve constant pressure and variable flow in which case flow setters may be replaced by pressure-independent control valves. This change in control approach may also involve support from installed coolant distribution units (CDUs).

The occupancy classifications and/or construction types of data centers disclosed herein may align with applicable building codes. For example, the main occupancy group may be classified as an electronic data processing facility, with accessory storage areas, and/or may be classified as required by the local Authority Having Jurisdiction. The construction type of an exemplary data center may be a fully sprinkler-protected structure (e.g., Type II-B). In some implementations, the construction type may vary based on regional construction materials, practices, and/or regulations.

Office space within an exemplary data center may include one or more private offices and/or open office space that may accommodate a plurality of data center operators. In some implementations, if a data center is the first facility on a campus, the office space of the data center may be expanded to include additional open office seating and/or one or more additional private offices. In some implementations, an exemplary data center may include additional rooms based on operational requirements. A data center may include restrooms in accordance with local regulations, for example restrooms may be included within each security zone of an exemplary data center. Restrooms may include one or more shower rooms, one or more toilets, one or more sinks, and/or one or more dressing areas. A data center may include a quiet room that may include a one or more countertops, one or more sinks, one or more mini-fridges, one or more electrical outlets, and/or furniture. A data center may additionally or alternatively include storage areas, for example accounting for at least 1% of the total footprint of the data center. An exemplary data center may include, within the one or more data halls, a designated disk destruction area and/or a wet room for liquid cooling rack preparation.

To facilitate equipment transportation, the doorways, hallways, and/or corridors of a data center may be designed to accommodate objects with approximate dimensions of 20 feet in length, 10 feet in height, and/or 6 feet in depth. A data center may include a dedicated battery storage area that may be protected by an automatic sprinkler system designed to meet Extra Hazard Group 1 design density specifications including, for example, 0.30 GPM per square foot over a 2,500 square foot area with a 500 GPM hose allowance. Dedicated battery backup storage areas may include air-sampling smoke detection systems in accordance with fire safety regulations. Server rack dimensions may be standardized. For example, a server rack may be 2 feet in width, 3 feet 6 inches in depth, and/or 8 feet in height.

The security and access control layout of an exemplary data center may include a security entry area, for example a main building entrance, a waiting area, and/or a security control room. A data center may include a “red zone,” for example a high-security area that may include server racks and/or other sensitive equipment. The red zone may include enhanced security measures, for example one or more controlled entry points, access authentication, and/or monitoring systems.

A data center may include one or more conference areas that may be designed to support staff activities and may include at least one conference room accessible from an entry lobby. A data center may additionally or alternatively include break rooms and/or food preparation areas. The mechanical areas of an exemplary data center may account for 10% to 30% of the total footprint which may ensure sufficient clearance for maintenance. The electrical areas of an exemplary data center may account for 10% to 20% of the total footprint, while building circulation may account for 3% to 10% of the total footprint.

An exemplary data hall may be designed for high floor loads, supporting up to 405 pounds per square foot for steel frame structures and 390 pounds per square foot for concrete frame structures. Server racks may weigh up to 5000 pounds when moved across a data hall floor. Certain structures associated with a data center, including data halls, centralized water treatment buildings, and/or security structures, may be designated as higher-risk facilities, corresponding to risk category IV, and may be held to stricter structural, mechanical, and electrical standards. A Structural Engineer of Record may be responsible for verifying dead, live, wind, and/or snow loads in compliance with applicable regulations. The full live load of server racks and/or cable racks may be accounted for in determining the total seismic mass.

Data center security may be structured using a zone-based approach, dividing an exemplary data center into green, yellow, and/or red zones. Security may be categorized into security zones and security elements. Security zones may physically divide spaces into high-and low-security regions using walls and/or electrically locking doors connected to an access control system. Security elements may include additional features such as access control points, metal detectors, and/or disk destruction stations as mentioned above. Security elements may include a yellow/red security station, a security turnstile (yellow zone entry), metal detection (red zone security checkpoint), disk destruction stations, disk destruction station rooms, an exterior fence, a pedestrian turnstile, a pedestrian gate, a guard booth, a crash-rated barrier arm, and/or a pin-badge talk-back access control stanchion. A “zone defense” security arrangement may be implemented, where each zone may allow for a different level of access, corresponding to a green, yellow, and red zone scheme. A security fence may be installed around the equipment yards, designating that space as a yellow zone.

Exemplary control systems may automate and/or monitor environmental conditions, electrical power distribution, and/or energy-efficiency measures. These systems may provide automation and/or monitoring of data center critical infrastructure, for example server racks and/or associated equipment. Control systems may not include ownership of fire or life-safety systems but may provide monitoring and/or alarming functionality where applicable.

An exemplary mechanical system may monitor temperature, pressure, humidity, and/or outside air conditions to maintain acceptable operating ranges for servers and/or associated IT equipment. A mechanical system may also evaluate local conditions and/or automate energy-saving measures by adjusting mechanical HVAC equipment. An exemplary electrical system may monitor power distribution from an incoming utility supply including the server-critical load, ensuring continuous and/or stable power delivery. An exemplary mechanical and/or electrical system may include a graphical user interface for visualizing real-time conditions, performing equipment overrides, and/or adjusting system setpoints. If any local conditions exceed acceptable thresholds, an exemplary control system may generate user notifications and/or alarms.

Historical telemetry and/or trending data for an exemplary data center may be collected and/or stored locally. An exemplary control system may include a built-in filtering and/or reporting functionality to enable customized data analysis. Control systems may be designed with redundancies to mitigate power loss, network issues, and/or equipment failures. Critical control components may rely on hard-wired connections for reliable automation interactions, while other data integrations may be performed through accepted network protocols.

The design of an exemplary data center, including doors, elevators, loading docks, and/or security passageways, may enable transport of large IT equipment skids and/or pallets into data halls. For example, an IT equipment skid may be 20 feet in length, 8 feet in height, and/or 4 feet in depth. Conventional data centers may be designed to accommodate only individual rack movement, whereas disclosed data centers may enable larger equipment skids to be maneuvered directly into a data hall. This approach may provide flexibility for future technological advancements that require larger infrastructure, ensuring compatibility with evolving IT equipment form factors. By accommodating large IT equipment skids, an exemplary data center may enable efficient equipment deployment while maintaining security and operational efficiency.

### Generator Buildings Separate From Data Hall Building

As disclosed herein, improved data center designs may locate secondary power generation equipment, such as generators and associated equipment, in a building separate from the data hall building. This building may be referred to as a generator building. The generator building may be spaced apart from the data hall building by a substantial distance, such as by greater than or equal to 100, 1000, or 5000 feet. By spacing the generator building apart from the data hall building, heat and exhaust outputs from the generator building may have little to no measurable effect on the data hall building, thereby obviating the need for complex and extensive heat- and exhaust-management systems that protect the data hall building from thermal and exhaust outputs of the generators.

With secondary power generation spaced apart from the data hall building by a substantial distance, the longer distances may introduce non-negligible losses for low-voltage runs. Thus, relying instead on higher-voltage runs may be more efficient. In order to achieve this, power from the generator building may be stepped up to a higher voltage level, for example 30 kV or more (and in some embodiments 34.5kV). At these voltage levels, losses between the generator building and the data hall building may be insignificant. To step up the voltage, one or more step-up transformers may be used. Transformers may introduce losses, but losses from use of transformers during secondary power generation may be smaller in magnitude compared to losses from transporting power across lower voltage lines, and the additional advantages of locating secondary power generation in a separate generator building may additionally justify any losses associated with transformer use.

This arrangement may provide several advantages, including reduced complexity in managing heat, exhaust, and other negative externalities at the data center itself; elimination of complex enclosures and exhaust pipes, reducing both cost and operational burden; and flexibility in allowing for reconfiguration data center campuses, for example allowing for optionality in generator installation and removal based on service requirements (e.g., when repurposing a data center from AI usage to cloud usage).

Additionally, requirements for climate management, maintenance, and security for the generator building may be significantly lower than corresponding requirements for the data hall building. This may allow for the generator building to be comparatively less complex as compared to the data hall building, and may allow for easier access to maintenance staff without the need for enhanced security measures needed in the data hall building and/or data hall. Thus, the arrangement may provide additional technological, economic, and security advantages in these regards.

### Switching Equipment Housed in Generator Building

In some embodiments, some or all switching equipment, such as medium voltage change-over panels, may be located in the generator building rather than in or proximate to the data hall building. The switching equipment may perform utility-to-generator changeover switching inside the generator building, rather than providing that functionality at another location. This may mean that only one medium voltage cable per lineup is fed from the generator building to the data center building, in some embodiments.

Additionally, medium voltage uninterruptible power supplies (UPS's) can be placed in the generator building, in some embodiments. In some embodiments, commercially available UPS devices may be used. In some embodiments, dual conversion UPS's may be used. In some embodiments, the generator building may not be environmentally conditioned. In some embodiments, if UPS devices are installed in the generator building and have environmental requirements, then a small conditioned room may be built in the building for the UPS devices inside the generator building.

Additional advantages may be afforded by locating switching equipment in the generator building, in addition to the secondary power generators themselves. For example, locating switching equipment in the generator building may reduce the number of cables running between the generator building and the data center, simplifying cable management. Furthermore, providing switching equipment and/or UPSs in the generator building may simplify data center layout, construction, and operation by eliminating the need for an electrical room inside the data center. Having no switching operation and no electrical room inside the data hall building may greatly reduce operations, maintenance, and security operational costs, including by obviating the need for electrical maintenance staff to be in close proximity to customer data and customer assets in the data hall.

### Placing Cooling Equipment at Ground Level

In some embodiments, locating secondary power generation equipment in a separate building spaced apart from the data hall building may free up ground-level space adjacent to the data hall building that would, in conventional designs, have been used for generators. By freeing up this ground-level space adjacent to the data hall building, cooling equipment may, in some embodiments, be placed at ground level adjacent to the data hall building, rather than being placed on the roof of the data hall building. In some embodiments, cooling equipment may be placed at ground level next to the data center building and next to medium voltage to low voltage transformers that transform power that runs from the generator building to the data hall building.

This placement may be beneficial because it may reduce the quantity of pipe runs going from the external mechanical equipment such, as cooling equipment, to the data hall building. Furthermore, if cooling equipment is not placed on the roof of the data hall building, then the roof may become significantly simpler to construct, lowering total construction costs and shortening construction time. Additionally, acoustic mitigations for noise generated by the cooling equipment may become simpler and cheaper, as mitigating noise sources at ground level is easier than mitigating them if placed on the roof.

### Exemplary Diagrams

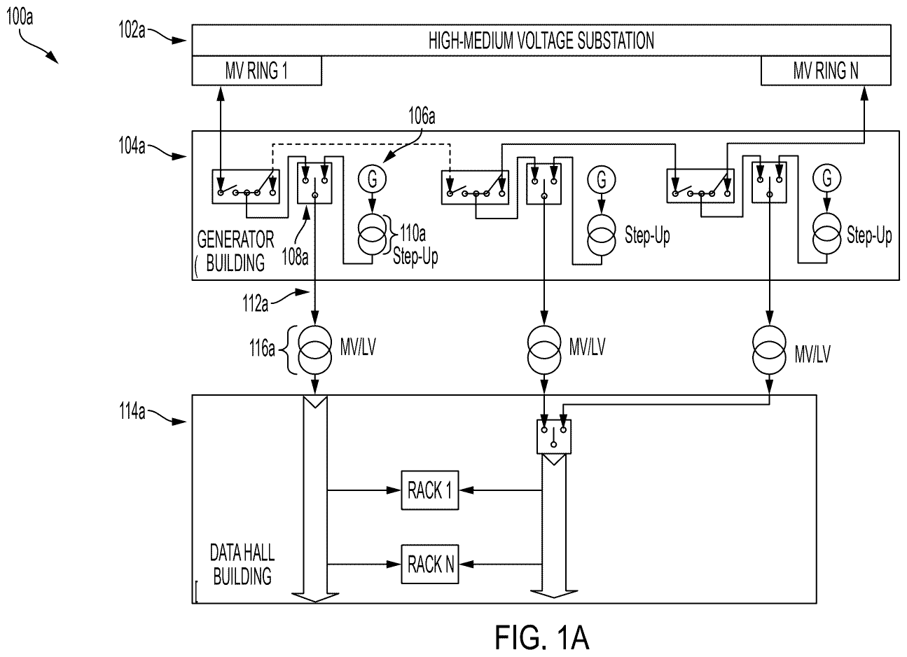

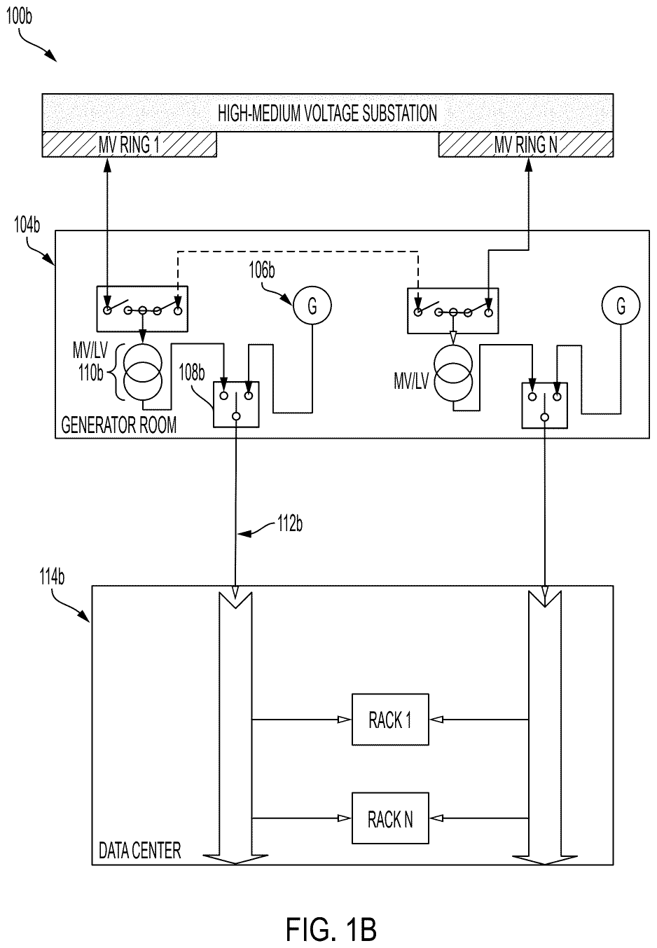

FIG. 1A depicts a data center 100a, in accordance with some embodiments. As shown in FIG. 1A, a high-medium voltage substation 102a may supply primary power to a generator building 104a, which may also include secondary power generators (e.g., 106a). The generator building may include switching equipment (e.g., 108a) configured to perform utility-to-generator changeover switching. Power from the generators may be stepped up by transformers (e.g., 110a) in the generator building and then delivered over medium-voltage cables (e.g., 112a) to the data hall building 114a. At the data hall building 114a, the medium-voltage power delivered from the generator building 104a may be stepped down, e.g., by medium-voltage-to-low-voltage transformers (e.g., 116a), and may then be delivered to computing devices inside the data hall of the data hall building 114a.

FIG. 1B depicts a data center 100b, in accordance with some embodiments. In some embodiments, the data center 100b depicted in FIG. 1B may share any one or more characteristics in common with the data center 100a depicted in FIG. 1A. The data center 100b shown in FIG. 1B may differ from the data center 100a shown in FIG. 1A in that the arrangement in FIG. 1B may perform switching on the low-voltage side and may rely on low-voltage runs from an electrical systems building 104b to a data hall building 114b (rather than relying on medium-voltage switching and medium-voltage runs from a generator building to a data hall building as shown in FIG. 1A). The arrangement shown in FIG. 1B may be preferable for shorter-distance runs between the electrical systems building 104b and the data hall building 114b, for example less than or equal to 100 feet or 60 feet (whereas the arrangement shown in FIG. 1A may be preferable for shorter-distance runs between the data hall building and the generator building).

The data center 100b depicted in FIG. 1B may be configured to perform switching on the low-voltage side and to rely on rely on low-voltage runs from an electrical systems building 104b to a data hall building 114b. These low-voltage runs may introduce some transmission losses, but the losses may be low due to the shorter (e.g., less than or equal to 100 feet or 60 feet) distance of the run. As shown, data center 100b may include high-medium voltage substation 102b, generators (e.g., 106b), step-down transformers (e.g., 110b), switching equipment (e.g., 108b), and low-voltage cables 112b

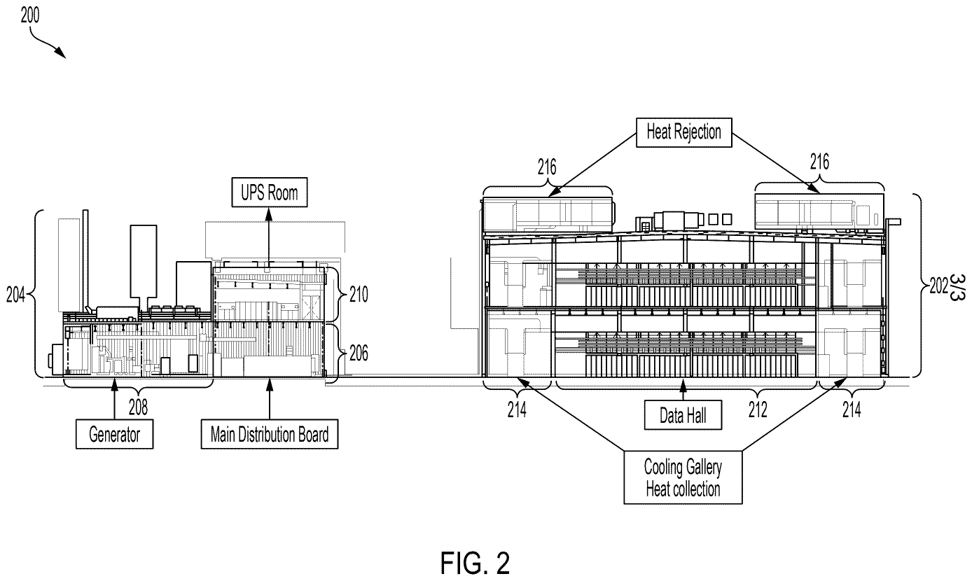

FIG. 2 depicts a data center 200, in accordance with some embodiments. As shown in FIG. 2, data center 200 may include a data hall building 202 and a separately situated electrical systems building, which may be separate from and spaced apart from the data hall building 202. The spacing between the data hall building 202 and the electrical systems building 204 may be greater than or equal to 40 feet, 60 feet, 80 feet, or 100 feet.

As shown in FIG. 2, electrical systems building 204 may include a generator room 208, a main distribution board room 206, and a UPS room 210. Electrical equipment housed in electrical systems building 204 may include generator equipment, a main switchboard (e.g., a low-voltage distribution board), medium-to-low voltage distribution transformer and its corresponding secondary medium-voltage power distribution equipment, and a transformer. As used herein, “low voltage” may refer to voltages that are about less than or equal to 1 kV; “medium voltage” may refer to ranges above about 1 kV and up to and including about the 36 and/or 52 kV distribution ranges, e.g., about 1 kV to about 52 kV; and “high voltage” may refer to voltage ranges above the medium-voltage range, for example above about 36 kV or above about 52 kV. In some embodiments, the main distribution board room 206 may be located at ground level. UPS room 210 may be located above ground level, in some embodiments directly above main distribution board room 206. Generator room 208 may be located at ground level, in some embodiments on a side of electrical systems building 204 that is furthest away from data hall building 202 (e.g., such that UPS room 206 may be located between generator room 208 and data hall building 202).

As shown in FIG. 2, data hall building 202 may include a data hall 212, one or more cooling galleries 214 for heat collection, and heat rejection equipment 216. Heat rejection equipment 216 may, in some embodiments, be located on a roof of the data hall building 202. The arrangement shown in FIG. 2 in which some or all electrical equipment is housed in electrical systems building 204 separate from data hall building 202 may provide advantages and efficiencies.

First, the arrangement shown in FIG. 2 may minimize or obviate the need for “oversized” heat rejection equipment for data hall building 202. In conventional arrangements in which generators are housed in or directly adjacent to a data hall building, those generators may run at low efficiencies, for example about 30% or worse, and may thus create significant excess heat in or directly adjacent to the data hall building when in use. The excess heat created may, in some embodiments, amount to an increase of 100% or more as compared to heat generation attributable to the data hall itself (or as compared to the entire data hall building) under normal operating conditions when generators and/or other secondary power generation equipment is not in use. Due to this excess heat generated when generators and/or other secondary power electrical equipment are in use, heat rejection equipment for data hall buildings that contain or are located immediately adjacent to said secondary power equipment generally are “oversized” and rated for, e.g., 100% more heat than is generated by the data hall building when the secondary power equipment is not in use. For example, heat rejection equipment may be oversized by at least 15-30% of the capacity of the cooling equipment for the data hall itself under normal use without secondary power generation.

The present designs, for example as shown in FIG. 2, avoid the need for oversized heat rejection equipment on data hall building 202. In the exemplary design shown, cooling equipment may be located on the roof of data hall building 202 (e.g., rather than at a ground-level location). Because data hall building 202 does not include generators or other secondary-power electrical equipment that is instead located in electrical systems building, the heat rejection equipment 216 on top of data hall building 202 does not need to be oversized with respect to the requirements of cooling equipment for the data hall building 202 itself. Instead, heat rejection equipment 216 for data hall building 202 simply needs to be rated for the cooling needs for of the data hall 212 when operating under normal conditions (and does not need to be rated for cooling needs of the generators or other secondary-power electrical equipment located in the electrical systems building).

Second, the arrangement shown in FIG. 2 may provide advantages in simplicity of construction, by allowing spatial separation of construction equipment and construction crews into the separate data hall building 202 and electrical systems building.

Third, the arrangement shown in FIG. 2 may provide advantages in maintaining security of the data hall building 202, because access to electrical systems building 204 may be independently provided at lower security levels than access to the higher-security data hall building 202.

Third, the arrangement shown in FIG. 2 may be more cost-effective than arrangements in which generators and associated equipment are placed in specialized generator enclosures immediately adjacent to the data hall building 202.

In the description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figure. The numerical ranges disclosed inherently support any range or value within the disclosed numerical ranges, including the endpoints, even though a precise range limitation is not stated verbatim in the specification because this disclosure can be practiced throughout the disclosed numerical ranges.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A data center comprising:
a data hall building housing a plurality of computer devices;
a secondary power generation building housing a plurality of secondary power generation devices, and a switchboard;
one or more cables electrically coupled to the one or more secondary power generation devices, to the utility power, and to the data hall building, wherein the one or more cables are configured to transport power from the secondary power generation building to the data hall building.

2. The data center of claim 1, wherein the secondary power generation building houses a plurality of medium-to-low-voltage distribution transformers coupled to utility power and configured to step-down the utility power to a transmission voltage, wherein the one or more cables are configured to transport power from the secondary power generation building to the data hall building at the transmission voltage.

3. The data center of claim 2, wherein the transmission voltage is less than or equal to 1000 V.

4. The data center of claim 1, wherein the secondary power generation building is spaced apart from the data hall building by a distance of greater than or equal to 60 feet.

5. The data center of claim 1, wherein the secondary power generation building houses switching equipment configured to perform utility-to-generator changeover switching.

6. The data center of claim 5, wherein the switching equipment comprises low-voltage changeover panels.

7. The data center of claim 1, wherein the data hall building comprises heat rejection equipment that has a heat rejection capacity calibrated for less than or equal to 110% of a nominal heat rejection capacity corresponding to a heat generation level of the data hall building when the data hall building is in an operational status.

8. The data center of claim 7, wherein the heat rejection equipment is located on a roof of the data hall building.

9. The data center of claim 1, wherein the data hall building comprises a cooling gallery at ground level.

10. A data center comprising:
a data hall building housing a plurality of computer devices;
a secondary power generation building housing a plurality of secondary power generation devices;
one or more transformers coupled to one or more of the plurality of secondary power generation devices and configured to step up power generated by the one or more secondary power generation devices to a transmission voltage;
one or more cables coupled to the one or more transformers and to the data hall building, wherein the one or more cables are configured to transport the stepped-up power from the one or more secondary power generation devices to the data hall building at the transmission voltage.

11. The data center of claim 10, wherein the transmission voltage is 37.5 kV.

12. The data center of claim 10, wherein the secondary power generation building is spaced apart from the data hall building by a distance of greater than or equal to 100 feet.

13. The data center of claim 10, wherein the secondary power generation building houses switching equipment configured to perform utility-to-generator changeover switching.

14. The data center of claim 13, wherein the switching equipment comprises medium-voltage changeover panels.

15. The data center of claim 10, comprising cooling equipment located at ground-level at a perimeter of the data hall building.

16. The data center of claim 10, wherein a roof of the data hall building is free of cooling equipment.
